(19) United States
(12) Patent Application Publication
(10) Pub. No.: US 2018/0233940 A1
(43) Pub. Date: Aug. 16, 2018

(54) MULTI-AXIS POWER COUPLING

(71) Applicant: QUALCOMM Incorporated, San Diego, CA (US)

(72) Inventors: Seong Heon Jeong, San Diego, CA (US); Mark White, II, San Diego, CA (US)

(21) Appl. No.: 15/432,796

(22) Filed: Feb. 14, 2017

(51) Int. Cl. H02J 7/02; H02J 50/12; H02J 50/80; H02J 50/90

(52) U.S. Cl. CPC H02J 7/025; H02J 50/90; H02J 50/80; H02J 50/12

(57) ABSTRACT

A wireless-power coupling system includes: a first power coupler comprising a first coil, the first coil comprising a first electrically-conductive loop; a second power coupler comprising a second coil, the second coil comprising a second electrically-conductive loop; and a third power coupler comprising a third coil, the third coil comprising a third electrically-conductive loop; where the first electrically-conductive loop and the second electrically-conductive loop are non-parallel relative to each other and overlap each other at a first plurality of locations of the first electrically-conductive loop; and where the first electrically-conductive loop and the third electrically-conductive loop are non-parallel relative to each other and overlap each other at a second plurality of locations of the first electrically-conductive loop, the first plurality of locations being distinct from the second plurality of locations.

### TECHNICAL FIELD

The disclosure relates generally to wireless power delivery to electronic devices, and in particular to power transmission and/or reception using multi-axis power coupling.

### BACKGROUND

An increasing number and variety of electronic devices are powered via rechargeable batteries. Such devices include mobile phones, portable music players, laptop computers, tablet computers, computer peripheral devices, communication devices (e.g., BLUETOOTH devices), digital cameras, hearing aids, and the like. While battery technology has improved, battery-powered electronic devices increasingly require and consume greater amounts of power. As such, these devices frequently require recharging. Rechargeable devices are often charged via wired connections that require cables or other similar connectors that are physically connected to a power supply. Cables and similar connectors may sometimes be inconvenient or cumbersome and have other drawbacks. Wireless power charging systems may allow users to charge and/or power electronic devices without physical, electro-mechanical connections, thus simplifying the use of the electronic device.

Powered implants are becoming increasingly common and put to increasing uses. The increase in uses has led to powered implants being disposed in a variety of locations in a carrier such as a person's body or a pet's body. Due to various factors such as the implants not being secured within a carrier and or movement of a portion of a carrier (e.g., a person's vein or organ) to which an implant is secured, an implant may be disposed at an unknown orientation at any given time. Further still, depending upon an application, a charging field supplied by a power transmitter for charging an implant may have a limited orientation relative to a carrier and/or the implant.

### SUMMARY

The following detailed description and accompanying drawings provide a better understanding of the nature and advantages of the disclosure.

An example of a wireless-power coupling system includes: a first power coupler comprising a first coil, the first coil comprising a first electrically-conductive loop; a second power coupler comprising a second coil, the second coil comprising a second electrically-conductive loop; and a third power coupler comprising a third coil, the third coil comprising a third electrically-conductive loop; where the first electrically-conductive loop and the second electrically-conductive loop are non-parallel relative to each other and overlap each other at a first plurality of locations of the first electrically-conductive loop; and where the first electrically-conductive loop and the third electrically-conductive loop are non-parallel relative to each other and overlap each other at a second plurality of locations of the first electrically-conductive loop, the first plurality of locations being distinct from the second plurality of locations.

Another example of a wireless-power coupling system includes: first power coupling means for coupling power wirelessly, the first power coupling means being disposed about a charging volume defined by the wireless-power coupling system to couple power primarily in a first direction; second power coupling means for coupling power wirelessly, the second power coupling means being disposed about the charging volume to couple power primarily in a second direction that is different from the first direction; and third power coupling means for coupling power wirelessly, the third power coupling means being disposed about the charging volume to couple power primarily in a third direction that is different from both the first direction and the second direction.

An example of a method of providing a composite magnetic field for wirelessly coupling power includes: disposing a plurality of wireless power couplers around a portion of a human body; and actuating the plurality of wireless power couplers to produce the composite magnetic field such that the composite magnetic field is substantially free of nulls within a volume of the portion of the human body.

An example of an implant for receiving power wirelessly includes: a housing having a longitudinal axis; a first power coupler being disposed around a perimeter of the implant and being substantially planar with a plane of the first power coupler being tilted with respect to the longitudinal axis by a tilt angle between 10° and 80°; and a second power coupler being disposed around the perimeter of the implant and being substantially planar with a plane of the second power coupler being tilted with respect to the longitudinal axis by a tilt angle between 10° and 80°, where the first power coupler and the second power coupler are substantially symmetrically disposed about the longitudinal axis of the housing.

### BRIEF DESCRIPTION OF THE DRAWINGS

Drawing elements that are common among the following figures may be identified using the same reference numerals.

With respect to the discussion to follow and in particular to the drawings, the particulars shown represent examples for purposes of illustrative discussion, and are presented in the cause of providing a description of principles and conceptual aspects of the disclosure. In this regard, no attempt is made to show implementation details beyond what is needed for a fundamental understanding of the disclosure. The discussion to follow, in conjunction with the drawings, makes apparent to those of skill in the art how embodiments in accordance with the disclosure may be practiced.

FIG. 1 is a functional block diagram of an example of a wireless power transfer system.

FIG. 2 is a functional block diagram of an example of another wireless power transfer system.

FIG. 3 is a schematic diagram of an example of a portion of transmit circuitry or receive circuitry of the system shown in FIG. 2.

FIG. 4 is a simplified diagram of a person wearing multi-axis wireless power couplers.

FIG. 5 is a perspective view of a multi-axis wireless power transmitter system shown in FIG. 4.

FIGS. 6A-6C are plots of a magnetic field produced by exciting a single coupler of the system shown in FIG. 5.

FIGS. 6D-6E are plots of a magnetic field produced by exciting both couplers of the system shown in FIG. 5.

FIG. 7A is a perspective view of an alternative configuration of power couplers for use in a multi-axis power coupling system.

FIG. 7B is a perspective view of two of the power couplers shown in FIG. 7A.

FIG. 7C is a perspective view of another two of the power couplers shown in FIG. 7A.

FIG. 8 is a perspective, cut-away view of an implant shown in FIG. 4.

FIG. 9 is a perspective view of a power-coupling coil, shown in FIG. 8, in the presence of a magnetic field.

FIG. 10 is a block flow diagram of a method of providing a composite magnetic field for wirelessly coupling power.

FIG. 11 is a block flow diagram of a method of providing energy to a load from wirelessly-received power.

### DETAILED DESCRIPTION

Wireless power transfer may refer to transferring any form of energy associated with electric fields, magnetic fields, electromagnetic fields, or otherwise from a transmitter to a receiver without physical electrical conductors attached to and connecting the transmitter to the receiver to deliver the power (e.g., power may be transferred through free space). The power output into a wireless field (e.g., a magnetic field or an electromagnetic field) may be received, captured by, or coupled to by a power receiving element to achieve power transfer. The transmitter transfers power to the receiver through a wireless coupling of the transmitter and receiver.

Techniques are discussed herein for wirelessly coupling power, particularly to a receiver at an unknown orientation with respect to a power transmitter. For example, a transmitter system may have power couplers such as electrically-conductive coils each disposed on a different axis. The power couplers can be disposed and excited such that a magnetic field produced inside a charging volume within the power couplers is free or substantially free of nulls to power a receiver inside the charging volume regardless of an orientation of a receiving antenna of the receiver. Similarly, a receiver system may have power couplers such as electrically-conductive coils each disposed on a different axis. The receiver system may be placed in a magnetic field and the different power couplers may couple to the magnetic field in different degrees with the receiver system receiving sufficient power, e.g., to power a device to perform an operation or to charge a battery, regardless of an orientation of the receiver system, such as a medical implant, relative to the magnetic field.

Items and/or techniques described herein may provide one or more of the following capabilities, as well as other capabilities not mentioned. Power may be provided wirelessly in a sufficient amount to operate a receiver (e.g., perform an operation, charge a battery, etc.) regardless of relative orientation of a transmitter to the receiver. A magnetic field for power coupling may be provided without blind areas. A substantially uniform magnetic field may be provided in a charging volume, e.g., inside a set of power couplers.

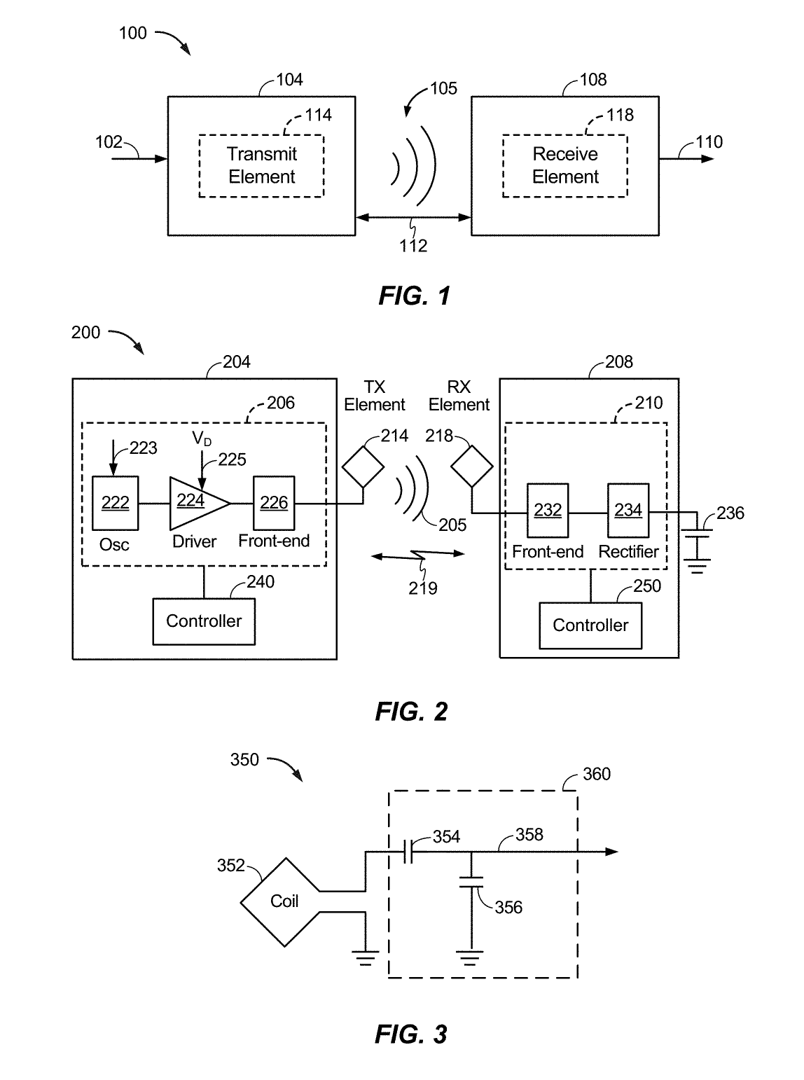

FIG. 1 is a functional block diagram of an example of a wireless power transfer system 100. Input power 102 may be provided to a transmitter 104 from a power source (not shown in this figure) to generate a wireless (e.g., magnetic or electromagnetic) field 105 for performing energy transfer. A receiver 108 may couple to the wireless field 105 and generate output power 110 for storing or consumption by a device (not shown in this figure) that is coupled to receive the output power 110. The transmitter 104 and the receiver 108 are separated by a non-zero distance 112. The transmitter 104 includes a power transmitting element 114 configured to transmit/couple energy to the receiver 108. The receiver 108 includes a power receiving element 118 configured to receive or capture/couple energy transmitted from the transmitter 104.

The transmitter 104 and the receiver 108 may be configured according to a mutual resonant relationship. When the resonant frequency of the receiver 108 and the resonant frequency of the transmitter 104 are substantially the same, transmission losses between the transmitter 104 and the receiver 108 are reduced compared to the resonant frequencies not being substantially the same. As such, wireless power transfer may be provided over larger distances when the resonant frequencies are substantially the same. Resonant inductive coupling techniques allow for improved efficiency and power transfer over various distances and with a variety of inductive power transmitting and receiving element configurations.

The wireless field 105 may correspond to the near field of the transmitter 104. The near field corresponds to a region in which there are strong reactive fields resulting from currents and charges in the power transmitting element 114 that do not significantly radiate power away from the power transmitting element 114. The near field may correspond to a region that up to about one wavelength, of the power transmitting element 114. Efficient energy transfer may occur by coupling a large portion of the energy in the wireless field 105 to the power receiving element 118 rather than propagating most of the energy in an electromagnetic wave to the far field.

The transmitter 104 may output a time-varying magnetic (or electromagnetic) field with a frequency corresponding to the resonant frequency of the power transmitting element 114. When the receiver 108 is within the wireless field 105, the time-varying magnetic (or electromagnetic) field may induce a current in the power receiving element 118. As described above, with the power receiving element 118 configured as a resonant circuit to resonate at the frequency of the power transmitting element 114, energy may be efficiently transferred. An alternating current (AC) signal induced in the power receiving element 118 may be rectified to produce a direct current (DC) signal that may be provided to charge an energy storage device (e.g., a battery) or to power a load.

FIG. 2 is a functional block diagram of an example of a wireless power transfer system 200. The system 200 includes a transmitter 204 and a receiver 208. The transmitter 204 (also referred to herein as power transmitting unit, PTU) is configured to provide power to a power transmitting element 214 that is configured to transmit power wirelessly to a power receiving element 218 that is configured to receive power from the power transmitting element 214 and to provide power to the receiver 208. Despite their names, the power transmitting element 214 and the power receiving element 218, being passive elements, may transmit and receive power and communications.

The transmitter 204 includes the power transmitting element 214, transmit circuitry 206 that includes an oscillator 222, a driver circuit 224, and a front-end circuit 226. The power transmitting element 214 is shown outside the transmitter 204 to facilitate illustration of wireless power transfer using the power receiving element 218. The oscillator 222 may be configured to generate an oscillator signal at a desired frequency that may adjust in response to a frequency control signal 223. The oscillator 222 may provide the oscillator signal to the driver circuit 224. The driver circuit 224 may be configured to drive the power transmitting element 214 at, for example, a resonant frequency of the power transmitting element 214 based on an input voltage signal (VD) 225. The driver circuit 224 may be a switching amplifier configured to receive a square wave from the oscillator 222 and output a sine wave.

The front-end circuit 226 may include a filter circuit configured to filter out harmonics or other unwanted frequencies. The front-end circuit 226 may include a matching circuit configured to match the impedance of the transmitter 204 to the impedance of the power transmitting element 214. As will be explained in more detail below, the front-end circuit 226 may include a tuning circuit to create a resonant circuit with the power transmitting element 214. As a result of driving the power transmitting element 214, the power transmitting element 214 may generate a wireless field 205 to wirelessly output power at a level sufficient for charging a battery 236, or powering a load.

The transmitter 204 further includes a controller 240 operably coupled to the transmit circuitry 206 and configured to control one or more aspects of the transmit circuitry 206, or accomplish other operations relevant to managing the transfer of power. The controller 240 may be a micro-controller or a processor. The controller 240 may be implemented as an application-specific integrated circuit (ASIC). The controller 240 may be operably connected, directly or indirectly, to each component of the transmit circuitry 206. The controller 240 may be further configured to receive information from each of the components of the transmit circuitry 206 and perform calculations based on the received information. The controller 240 may be configured to generate control signals (e.g., signal 223) for each of the components that may adjust the operation of that component. As such, the controller 240 may be configured to adjust or manage the power transfer based on a result of the operations performed by the controller 240. The transmitter 204 may further include a memory (not shown) configured to store data, for example, such as instructions for causing the controller 240 to perform particular functions, such as those related to management of wireless power transfer.

The receiver 208 (also referred to herein as power receiving unit, PRU) includes the power receiving element 218, and receive circuitry 210 that includes a front-end circuit 232 and a rectifier circuit 234. The power receiving element 218 is shown outside the receiver 208 to facilitate illustration of wireless power transfer using the power receiving element 218. The front-end circuit 232 may include matching circuitry configured to match the impedance of the receive circuitry 210 to the impedance of the power receiving element 218. As will be explained below, the front-end circuit 232 may further include a tuning circuit to create a resonant circuit with the power receiving element 218. The rectifier circuit 234 may generate a DC power output from an AC power input to charge the battery 236, as shown in FIG. 3. The receiver 208 and the transmitter 204 may additionally communicate on a separate communication channel 219 (e.g., BLUETOOTH, ZIGBEE, cellular, etc.). The receiver 208 and the transmitter 204 may alternatively communicate via in-band signaling using characteristics of the wireless field 205.

The receiver 208 may be configured to determine whether an amount of power transmitted by the transmitter 204 and received by the receiver 208 is appropriate for charging the battery 236. The transmitter 204 may be configured to generate a predominantly non-radiative field with a direct field coupling coefficient (k) for providing energy transfer. The receiver 208 may directly couple to the wireless field 205 and may generate an output power for storing or consumption by a battery (or load) 236 coupled to the output or receive circuitry 210.

The receiver 208 further includes a controller 250 that may be configured similarly to the transmit controller 240 as described above for managing one or more aspects of the wireless power receiver 208. The receiver 208 may further include a memory (not shown) configured to store data, for example, such as instructions for causing the controller 250 to perform particular functions, such as those related to management of wireless power transfer.

As discussed above, transmitter 204 and receiver 208 may be separated by a distance and may be configured according to a mutual resonant relationship to try to minimize transmission losses between the transmitter 204 and the receiver 208.

FIG. 3 is a schematic diagram of an example of a portion of the transmit circuitry 206 or the receive circuitry 210 of FIG. 2. While a coil, and thus an inductive system, is shown in FIG. 3, other types of systems, such as capacitive systems for coupling power, may be used, with the coil replaced with an appropriate power transfer (e.g., transmit and/or receive) element. As illustrated in FIG. 3, transmit or receive circuitry 350 includes a power transmitting or receiving element 352 and a tuning circuit 360. The power transmitting or receiving element 352 may also be referred to or be configured as an antenna such as a “loop” antenna. The term “antenna” generally refers to a component that may wirelessly output energy for reception by another antenna and that may receive wireless energy from another antenna. The power transmitting or receiving element 352 may also be referred to herein or be configured as a “magnetic” antenna, such as an induction coil (as shown), a resonator, or a portion of a resonator. The power transmitting or receiving element 352 may also be referred to as a coil or resonator of a type that is configured to wirelessly output or receive power. As used herein, the power transmitting or receiving element 352 is an example of a “power transfer component” of a type that is configured to wirelessly output and/or receive power. The power transmitting or receiving element 352 may include an air core or a physical core such as a ferrite core (not shown).

When the power transmitting or receiving element 352 is configured as a resonant circuit or resonator with tuning circuit 360, the resonant frequency of the power transmitting or receiving element 352 may be based on the inductance and capacitance. Inductance may be simply the inductance created by a coil and/or other inductor forming the power transmitting or receiving element 352. Capacitance (e.g., a capacitor) may be provided by the tuning circuit 360 to create a resonant structure at a desired resonant frequency. As a non-limiting example, the tuning circuit 360 may comprise a capacitor 354 and a capacitor 356, which may be added to the transmit or receive circuitry 350 to create a resonant circuit.

The tuning circuit 360 may include other components to form a resonant circuit with the power transmitting or receiving element 352. As another non-limiting example, the tuning circuit 360 may include a capacitor (not shown) placed in parallel between the two terminals of the circuitry 350. Still other designs are possible. For example, the tuning circuit in the front-end circuit 226 may have the same design (e.g., 360) as the tuning circuit in the front-end circuit 232. Alternatively, the front-end circuit 226 may use a tuning circuit design different than in the front-end circuit 232.

For power transmitting elements, the signal 358, with a frequency that substantially corresponds to the resonant frequency of the power transmitting or receiving element 352, may be an input to the power transmitting or receiving element 352. For power receiving elements, the signal 358, with a frequency that substantially corresponds to the resonant frequency of the power transmitting or receiving element 352, may be an output from the power transmitting or receiving element 352. Although aspects disclosed herein may be generally directed to resonant wireless power transfer, persons of ordinary skill will appreciate that aspects disclosed herein may be used in non-resonant implementations for wireless power transfer.

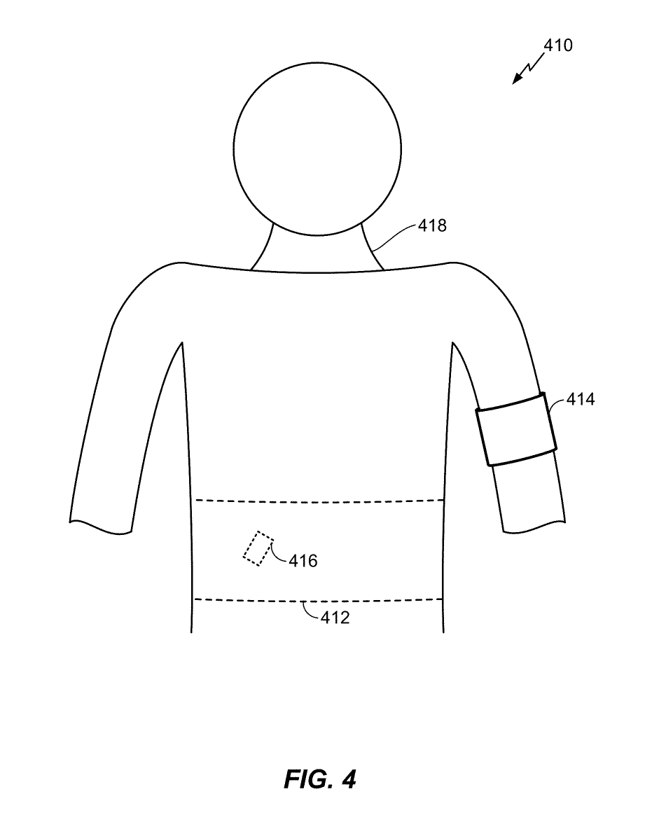

Referring to FIG. 4, a wireless power environment 410 includes two examples of wearable transmitter systems, here, a belt transmitter system 412 and an arm cuff transmitter system 414, and an example of an implant 416 that includes a wireless power receiver system. Each of the transmitters systems 412, 414 may be referred to simply as a system or a transmitter, and each comprise a wearable housing containing power couplers. The belt transmitter system 412 is shown as being disposed about a midsection (e.g., a lower torso portion) of a user 418, although other configurations and locations are possible, such as being disposed lower or higher on the user 418, being thinner than as shown, etc. The systems 412, 414 may each include a multi-axis coil set as the transmitter element 214 (FIG. 2), with multiple coils being disposed about an axis and this axis may be shared with the user 418. For example, when disposed for use, the system 412 may have coils disposed along a common axis with a torso of the user 418, and the system 414 may have coils disposed along a common axis of an arm of the user 418. The coils may be disposed about an axis without being centered on that axis. Further, other sizes, shapes, and applications of transmitter systems may be used such as a system disposed about a forearm of the user 418, a system disposed around a thigh of the user 418, a system disposed around a calf of the user 418, etc. The transmitter systems discussed herein may each include a housing for conductive coils with the housing being made of a flexible material that may be wrapped around and possibly at least partially conformed to an external surface of the user 418. Further, transmitter systems discussed herein may provide null-free magnetic fields within charging volumes internal to the transmitter systems. Either or both of the transmitter systems 412, 414 may include a power supply, or may be connected to a power supply that is separate from the respective transmitter system 412, 414. A description that a system or coil is disposed “around” an item such as around a perimeter of a charging volume or carrier, or around axis, does not require a particular shape, e.g., round/circular, of the item.

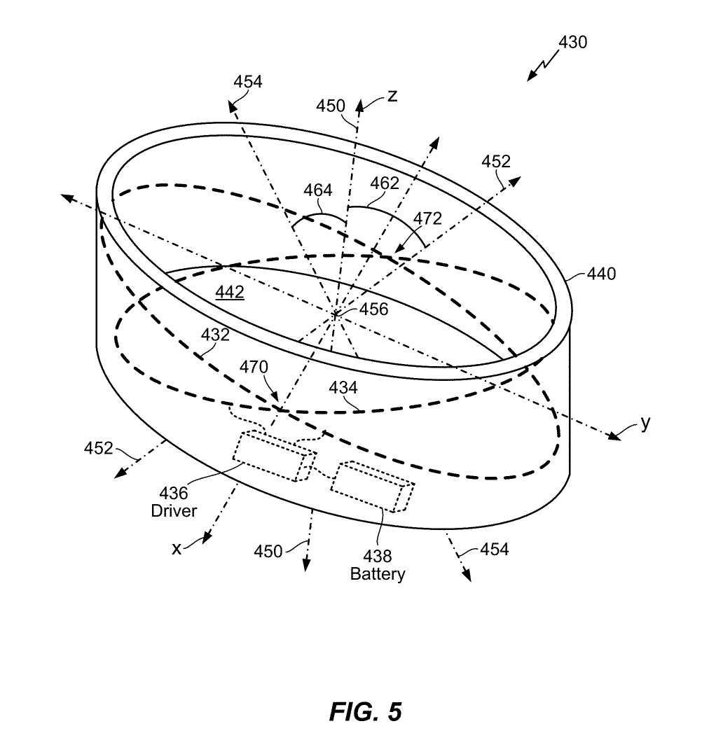

Referring also to FIG. 5, a multi-axis wireless power transmitter system 430, which is an example of the transmitter system 412, includes power couplers 432, 434, a driver 436, a battery 438, and a carrier 440. The system 430 is configured to transmit wireless power from transmitters disposed along different axes, and thus with different orientations, to help facilitate power transfer to a receiver regardless of orientation of the receiver relative to the system 430. The system 430 includes the two power couplers 432, 434, but other quantities of power couplers may be used. For example, as discussed below, a wireless power transmitter (or a wireless power receiver) may include four power couplers. The carrier 440 is configured to be worn by the user 418. For example, the carrier 440 may be configured as a belt that can be detached from itself, positioned about a portion of the user 418, and attached to itself to complete the power couplers 432, 434 and be secured against the user 418. Alternatively, the carrier 440 may be a garment or a portion of a garment such as a portion of a shirt or blouse that can be worn by the user 418. The carrier 440 has a tubular shape, here with an oval cross-sectional shape along an axis 450 although other cross-sectional shapes may be used (e.g., circular, rectangular, etc.). The system 430 is configured to provide a magnetic field in a charging volume 442 defined by the power couplers 432, 434, and possibly outside of the charging volume 442, that is without nulls or substantially without nulls. That is, the system 430 is preferably configured to provide a magnetic field in the charging volume 442 of sufficient magnitude to charge a device, e.g., an implant, that is disposed within the charging volume 442. The charging volume 442 includes an area defined by a perimeter of the power couplers 432, 434 over a height of the power couplers 432, 434 along the axis 450, and possibly extending slightly beyond (e.g., 5% or 10% beyond) the power couplers 432, 434 along the axis 450. As shown, the carrier 440 contains the power couplers 432, 434, the driver 436, and the battery 438. Alternatively, the driver 436 and/or the battery 438 may be disposed outside of the carrier 440 and the carrier 440 may have one or more ports configured to couple to the driver 436 and/or the battery 438. In the example of FIG. 5, the power couplers 432, 434 are similarly sized and shaped, but this is not required.

In the example of FIG. 5, the power couplers 432, 434 are electrically-conductive coils disposed such that the power couplers 432, 434 are planar coils having different axes. That is, the electrically-conductive coils, here electrically-conductive loops, are non-parallel such that an axis 452 of the power coupler 432 is not collinear with an axis 454 of the power coupler 434. As shown, the axis 450, the axis 452, and the axis 454 all share, and pass through, a center 456 that is shared by the power couplers 432, 434 and the carrier 440, although this is not required. For example, the axes 450, 452, 454 may not all pass through the center 456 depending on the locations of the power couplers 432, 434 relative to the carrier 440 and/or relative to each other. The axis 452 of the power coupler 432 is disposed at a displacement angle 462 relative to the axis 450 and the axis 454 of the power coupler 434 is disposed at a displacement angle 464 relative to the axis 450. The displacement angle 462 of the power coupler 432 may be the same as, or different than, the displacement angle 464 of the power coupler 434. The displacement angles 462, 464 of the power couplers 432, 434 are the angles between the axis 450 and the axes 452, 454. Related to the displacement angles 462, 464 are tilt angles of the power couplers 432, 434 that are the angles between the axis 450 and planes of the power couplers 432, 434. The tilt angles are 90° minus the displacement angles 462, 464, respectively. Depending on the geometry of the carrier 440, e.g., due to a size of the user 418, the axis 452 may not be able to be perpendicular to the axis 454, i.e., the sum of the displacement angle 462 and the displacement angle 464 may not be 90°. Preferably, the further the sum of the displacement angle 462 and the displacement angle 464 is from 90°, the closer the relative phase of the powers provided to the power couplers 432, 434 is to 0°, i.e., being in phase. In the example shown in FIG. 5, the power couplers 432, 434 overlap each other at two points 470, 472 along an x-axis, the axis 450 is collinear with a z-axis, and the axes 452, 454 lie in a y-z plane defined by the z-axis and a y-axis. The power couplers 432, 434 are electrically isolated from each other such that while the power couplers 432, 434 overlap, the power couplers 432, 434 are not electrically coupled to each other, except through the driver 436.

While the power couplers 432, 434 are discussed as comprising planar coils, the coils may not be planar, but substantially planar. For example, a coil may deviate slightly from a plane passing through the coil, such as by deviating from the plane less than about 20%, or less than about 10%, of a length (or diameter, or length of a major axis) of the coil. The coil may be said to be substantially disposed in such a plane. For simplicity, reference to a planar coil includes a substantially planar coil and vice versa. For purposes of discussing displacement angles, tilt angles and other geometry, the coils are treated as being planar.

The driver 436 and the battery 438 are configured to provide power to the power couplers 432, 434. The driver 436 may contain one or more power amplifiers configured to provide power of a desired voltage level and/or a desired current level, and possibly with a desired phase. The driver 436 may be configured to provide different powers (e.g., voltage levels, current levels, and/or phases) to the different power couplers 432, 434. For example, the driver 436 may include a separate power amplifier for each of the power couplers 432, 434. The driver 436 may be configured to provide power selectively to the power couplers 432, 434, e.g., powering only one of the power couplers 432, 434 at a time, or powering both power couplers 432, 434 concurrently. The driver 436 may be configured to provide power to the power couplers 432, 434 with desired relative phases, e.g., with the power provided to the power coupler 432 having a desired phase relative to the power provided to the power coupler 434. For example, the power to the power couplers 432, 434 may be in phase with each other, or substantially in phase with each other (e.g., preferably less than 90°, less than 50°, less than 30°, less than 10°, or less than 5° out of phase from each other). The desired relative phase and/or an acceptable relative phase of the power provided to the power couplers 432, 434 may depend on the power couplers 432, 434, e.g., on relative alignment of the power couplers 432, 434, with the acceptable relative phase being the maximum phase difference in the power to the power couplers 432, 434 while still providing sufficient charging power anywhere in the charging volume 442 to charge a desired device. For example, if the power couplers 432, 434 are planar coils disposed perpendicular to each other, then the acceptable relative phase of the power provided to the power couplers 432, 434 may be further away from being in phase (0° phase difference) than if the power couplers 432, 434 are not perpendicular to each other.

The power couplers 432, 434, combined with the driver 436, are configured to provide a substantially null-free, and possibly substantially uniform (e.g., varying less than 30% in magnitude), magnetic field in the charging volume 442 in response to receiving power from the driver 436. Particularly if the axis 452 is not perpendicular to the axis 454, the driver 436 may provide power to the power couplers 432, 434 at or nearly in phase with respect to each other to help provide the substantially null-free magnetic field in the charging volume 442. The closer the displacement angles 462, 464 are to being perpendicular to each other, the less the relative phase of the powers to the power couplers 432, 434 will affect the null-free nature of the magnetic field in the charging volume 442. For example, if the displacement angles 462, 464 are perpendicular to each other, then the relative phase (i.e., phase difference) of the power to the power couplers 432, 434 is largely irrelevant, and could even be close to or equal to 180°, but is preferably less than 90°. Further, if the power couplers 432, 434 are perpendicular to each other, then there will be very little mutual coupling between the power couplers 432, 434.

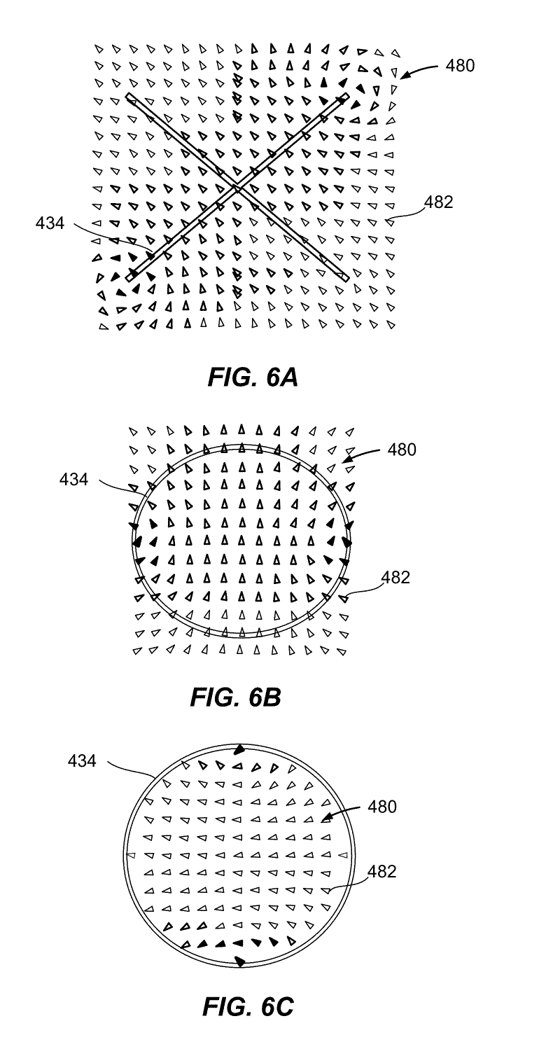

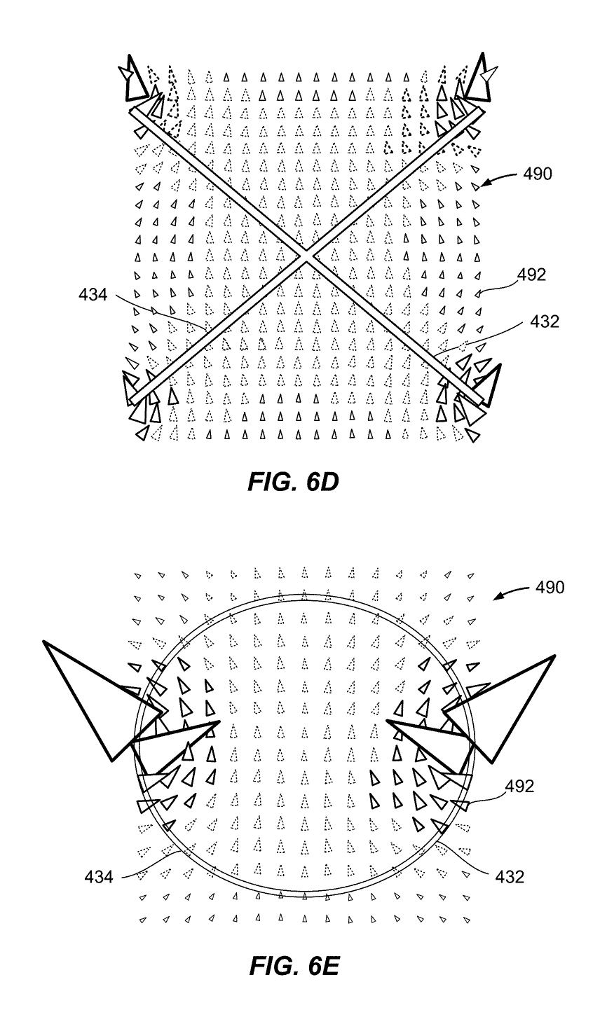

Referring to FIGS. 6A-6C, a magnetic field 480 produced by exciting only the power coupler 434 is null-free in the charging volume 442. FIG. 6A shows the magnetic field 480 in the y-z plane of FIG. 5. FIG. 6B shows the magnetic field 480 in the x-z plane of FIG. 5. FIG. 6C shows the magnetic field 480 in the x-y plane of FIG. 5. In FIGS. 6A-6C, directions of the magnetic field 480 are indicated by directions of arrows 482 at their respective locations while magnitudes of the magnetic field 480 are indicated by sizes of the arrows 482 at their respective locations. The magnetic field 480 shown in FIGS. 6A-6C is a computer-simulated field and includes no nulls in the charging volume 442 (FIG. 5), i.e., the magnitude (intensity) of the magnetic field 480 is not zero anywhere in the charging volume 442. Power delivery to a receiver that is perpendicular to the y-z plane will be nearly the same if the receiver lies in the x-y plane or in the x-z plane.

Referring to FIGS. 6D-6E, a magnetic field 490 produced by exciting the power coupler 432 and the power coupler 434 is null-free in the charging volume 442. FIG. 6D shows the magnetic field 490 in the y-z plane of FIG. 5. FIG. 6E shows the magnetic field 490 in the x-z plane of FIG. 5. In FIGS. 6D-6E, directions of the magnetic field 490 are indicated by directions of arrows 492 at their respective locations while magnitudes of the magnetic field 490 are indicated by sizes of the arrows 492 at their respective locations. The magnetic field 490 shown in FIGS. 6D-6E is a computer-simulated field and includes no nulls in the charging volume 442 (FIG. 5), i.e., the magnitude (intensity) of the magnetic field 490 is not zero anywhere in the charging volume 442. Power delivery to a receiver that is perpendicular to the y-z plane will be nearly the same if the receiver lies in the x-y plane or in the x-z plane.

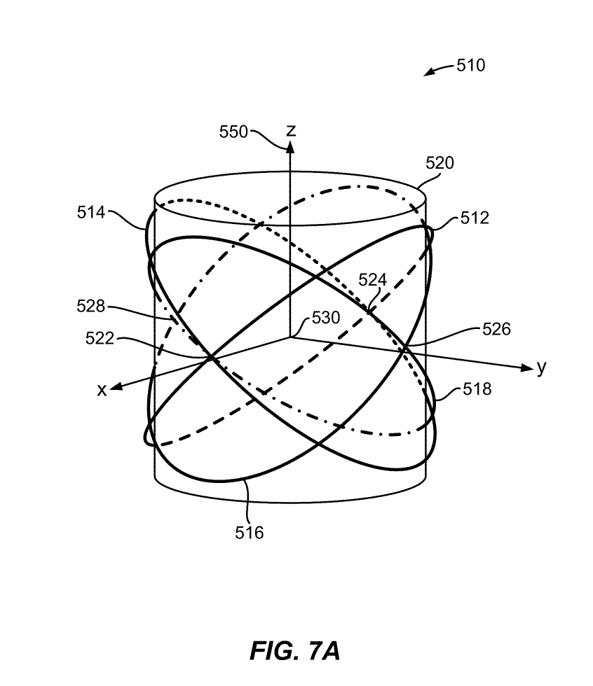

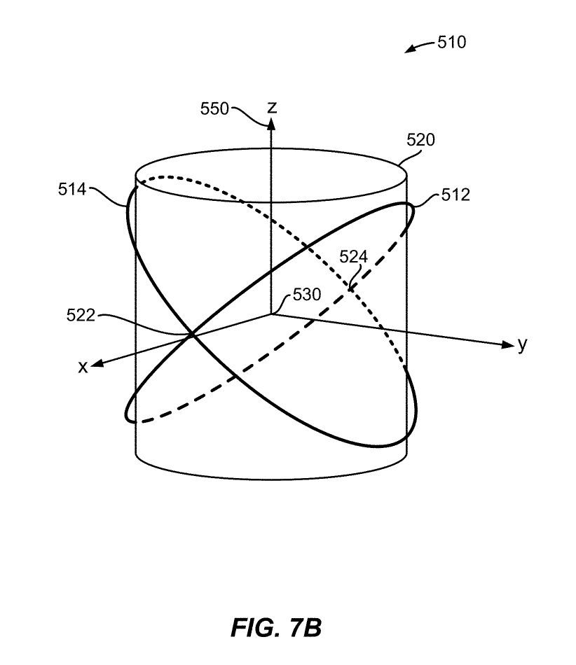

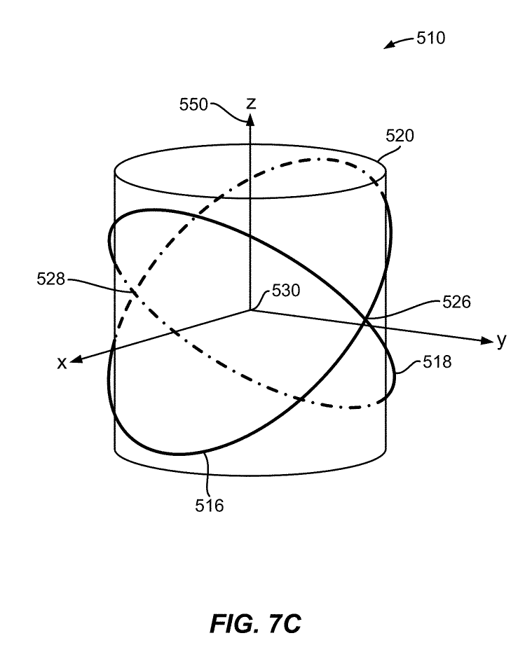

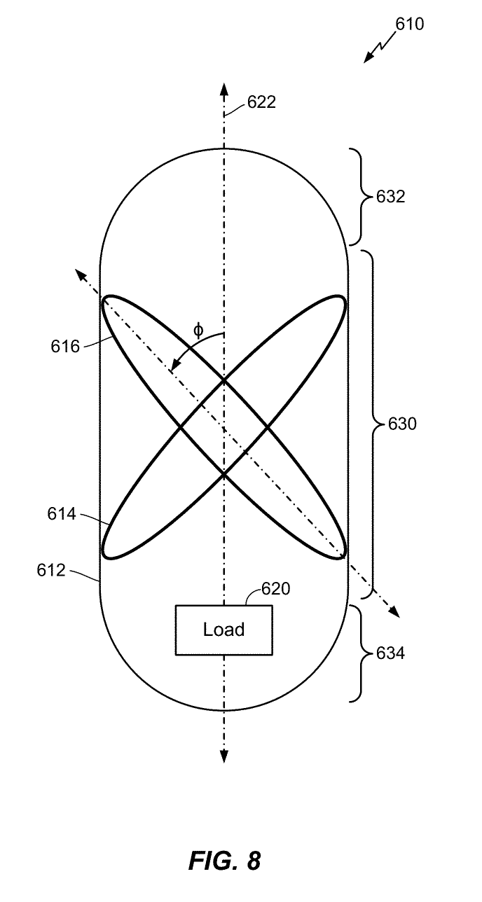

Referring to FIGS. 7A-7C, with further reference to FIG. 5, an alternative configuration 510 of power couplers for use in a multi-axis power transmitter system includes power couplers 512, 514, 516, 518. For clarity and ease of understanding, FIG. 7B shows only the power couplers 512, 514, and FIG. 7C shows only the power couplers 516, 518. The power couplers 512, 514, 516, 518 provide a charging volume 520 in which a substantially null-free magnetic field is provided by the power couplers 512, 514, 516, 518 in response to be powered. While the charging volume 520 is not a solid object, in FIGS. 7A-7C the power couplers 512, 514, 516, 518 are shown with portions behind the charging volume 520 in dashed lines to assist with visualization of the configuration 510. In the configuration 510, the power couplers 512, 514 are perpendicular to each other and the power couplers 516, 518 are perpendicular to each other. Here, the power couplers 512, 514 comprise electrically-conductive planar coils that overlap at points 522, 524 of the power coupler 512 disposed along an x-axis and where the electrically-conductive coils are perpendicular to each other at the points 522, 524 when viewed along the x-axis. Similarly, the power couplers 516, 518 comprise electrically-conductive planar coils that overlap at points 526, 528 of the power coupler 516 disposed along a y-axis and where the electrically-conductive coils are perpendicular to each other at the points 526, 528 when viewed along the y-axis. The power coupler 512 also overlaps with the power coupler 516, but at points along the power coupler 512 that are distinct from the points 522, 524. The same can be said for the power coupler 514 relative to the power couplers 516, 518, and for each of the power couplers 516, 518 relative to each of the power couplers 512, 514. In the alternative configuration 510, the power couplers 512, 514, 516, 518 are symmetrical, being similarly sized and shaped (here, elliptically shaped), and substantially symmetrically positioned about the charging volume 520. The coils 512, 514, 516, 518 are substantially symmetrically positioned in that the coils 512, 514 are disposed about 180° (e.g., between 170° and 190°) around an axis 550 of the charging volume 520 from each other, the coils 516, 518 are disposed about 180° (e.g., between 170° and 190°) around the axis 550 from each other, and the coils 512, 514 are disposed about 90° around the axis 550 from the coils 516, 518. Other configurations, however, may be used such as other symmetrical configurations, non-symmetrical configurations, other shapes of coils, and/or different coils in a single configuration having different shapes, etc.

For the example shown in FIG. 7A, the planar coils of the power couplers 512, 514, 516, 518 each have the same displacement angle (and consequently the same tilt angle) with respect to the axis 550 (here, a z-axis) of the charging volume 520 but have different rotation angles about the axis 550. That is, projections of axes of the planar coils of the power couplers 512, 514, 516, 518 have different angles relative to the axis 550 with respect to a reference direction such as the positive-x direction along the x-axis. If ϕ is the angle from the positive-x axis to the power coupler axis projected onto the x-y plane, then the value of ϕ for each of the power couplers 512, 514, 516, 518 will be different. Here, relative to the axis 550 of the charging volume 520, the direction of the axis of the power coupler 512 is opposite the direction of the axis of the power coupler 514, the direction of the axis of the power coupler 516 is opposite the direction of the axis of the power coupler 518, the direction of the axis of the power coupler 512 is perpendicular to the direction of the axis of the power coupler 516 and the axis of the power coupler 518, and the direction of the axis of the power coupler 514 is perpendicular to the direction of the axis of the power coupler 516 and the direction of the axis of the power coupler 518. Thus, in the example shown in FIG. 7A, the value of ϕ for the power coupler 512 will be 180° different than the value of ϕ for the power coupler 514, and the value of ϕ for the power coupler 516 will be 180° different than the value of ϕ for the power coupler 518. Further in this example, the value of ϕ for the power coupler 512 will be 90° different than the value of ϕ for the power coupler 516, and the value of ϕ for the power coupler 514 will be 90° different than the value of ϕ for the power coupler 518. That is, the pair of coils of the power couplers 512, 514 is similar to the pair of coils of the power couplers 516, 518, but rotated 90° about the axis 550. The relative angles of the power couplers 512, 5124, 516, 518, or the power couplers 432, 434, may be slightly different than those discussed, e.g., due to manufacturing tolerances or design choice, and thus a reference to a specific angle, e.g., perpendicular, 90°, opposite, 180°, includes other angles close to the specific angle referenced, e.g., within 10% of the referenced angle. A first intersection line representative of an intersection of a first plane in which the power coupler 512 is substantially disposed and a second plane in which the power coupler 514 is substantially disposed intersects a second intersection line representative of an intersection of the first plane and a third plane in which the power coupler 516 is substantially disposed only at a center 530 of the charging volume 520. The power couplers 512, 514, 516, 518 as shown share the center 530, i.e., the power couplers 512, 514, 516, 518 all have the same center, here the center 530. Further, a third intersection line representative of an intersection of the third plane and a fourth plane in which the power coupler 518 is substantially disposed intersects the first intersection line at the center of the charging volume 520, intersects the axis 550 at the center, is perpendicular to the first intersection line, and is perpendicular to the axis 550.

Similar to the discussion above with respect to FIG. 5, the power couplers 512, 514, 516, 518 may be powered individually, or in combinations, and if in a combination, with similar or different phases. Thus, for example, the power couplers 512, 514 may be powered as a pair and/or the power couplers 516, 518 may be powered as a pair, i.e., concurrently with or without the same phase. Further, other combinations of the power couplers 512, 514, 516, 518 may be powered such as the power couplers 512, 516 being powered as a pair, the power couplers 512, 516, 518 being powered as a combination, etc. In any combination, the power couplers 512, 514, 516, 518 in the combination may be powered with various relative phase differences, including powering the power couplers 512, 514, 516, 518 in the combination with no phase difference, i.e., in phase with each other. As another example, the power couplers 512, 514 could be powered in phase with respect to each other and the power couplers 516, 518 powered in phase with respect to each other and 90° out of phase with respect to the power couplers 512, 514. The power couplers 512, 514, 516, 518 are electrically isolated from each other such that current in any of the power couplers 512, 514, 516, 518 is inhibited from flowing into any of the other power couplers 512, 514, 516, 518.

Referring to FIG. 8, a biomedical implant 610 includes a housing 612, coils 614, 616, and a load 620. The implant 610 is an example of the implant 416 shown in FIG. 4. The load 620 is electrically coupled to the coils 614, 616. Similar to FIGS. 5 and 7, the coils 614, 616 are electrically conductive, each having an elliptical shape, and are substantially symmetrically disposed about the implant 610. Other configurations, however, including other quantities of coils (e.g., two coils, four coils, more than four coils), different symmetrical layouts, non-symmetrical layouts, non-elliptical shapes, and/or different shapes for different coils, etc. may be used.

The housing 612 is preferably sized and shaped to allow desired relationships between the coils 614, 616. Preferably, the housing is sized and shaped to allow the coils 614, 616 to be disposed perpendicular to each other where the coils 614, 616 overlap. This, however, may not be possible depending upon the size (e.g., the length and width) of the housing 612. As shown in FIG. 7A, the housing 612 may be capsule-shaped with a middle section 630 that has a cylindrical shape over a length of the housing 612 and two end sections 632, 634 that have dome or hemispherical shapes. Other shapes of housings and coils may be used, such as rectangular cross-section housings and rectangular coils. Further, in this example, the coils 614, 616 are directed opposite each other. The coils 614, 616 extend around a perimeter of the housing 612 in an interior of the housing 612 shown in FIG. 8, but other configurations are possible. For example, the coils 614, 616 could be disposed around an exterior perimeter of the housing 612, with the coils 614, 616 preferably being covered by with a biologically inert material to separate the coils 614, 616 from a body in which the implant 610 is disposed. The shape of each of the coils 614, 616 is similar to a cross-sectional shape of the housing 612 along a plane of the respective coil 614, 616. The coil 616 is tilted by a tilt angle ϕ with respect to a longitudinal axis 622 of the housing 612. The tilt angle ϕ will vary depending upon the geometry of the housing 612, but is preferably between 10° and 80°, is more preferably between 30° and 60°, and is more preferably between 40° and 50°. The coil 614 is similarly tilted with respect to the longitudinal axis 622 and is substantially symmetrically disposed in the housing 612 relative to the coil 616 (e.g., the coil 614 is approximately 180° (e.g., between 170° and 190°) rotated about the longitudinal axis 622 relative to the coil 616).

The housing 612 is configured for insertion into a human body and to hold the load 620 and the coils 614, 616. The housing 612, or at least an exterior of the housing 612, may be made of a biologically inert material. The housing is sized and shaped to accommodate the load 620 inside the housing 612. The load 620 may comprise an electrical circuit for performing one or more operations such as providing a stimulus such as an electrical, optical, mechanical, and/or acoustic stimulus. The load 620 may also or alternatively comprise a rectifier configured to rectify alternating-current energy induced in the coils 614, 616 into direct-current energy that may be provided to a circuit or an energy storage device. The load 620 may also or alternatively comprise an energy storage device such as a battery for storing energy that may be provided to another portion of the load 620 such as the electrical circuit.

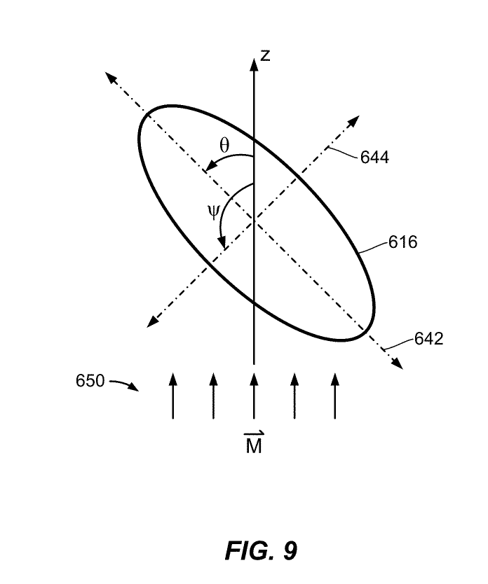

The implant 610 is configured to help couple to a magnetic field sufficiently to power the load 620 regardless of an orientation relative to a direction of the magnetic field by being a multi-axis device with the coils 614, 616 having different axes with different directions of maximum magnetic coupling. Each of the coils 614, 616 has a respective axis that is normal to a plane of the coil 614, 616. The respective axis is the direction of maximum magnetic coupling for the coil 614, 616 such that the coil 614, 616 will couple best to the magnetic field when the magnetic field direction is aligned with the respective axis, here, an axis normal to the plane of the coil 614, 616. As shown in FIG. 9, a plane of the coil 616 is defined by a longitudinal axis 642 and a width axis 644. The direction of maximum magnetic coupling is normal to these two axes 642, 644. The longitudinal axis 642 of the coil 616 is tilted relative to a z-axis by an angle θ that is greater than 0° and less than 90° and the width axis 644 of the coil 616 is tilted relative to the z-axis by an angle ψ. If M₀ is the magnetic coupling of a magnetic field 650 aligned along the z-axis if the plane of the coil 616 was disposed perpendicular to the magnetic field 650 (i.e., the axes 642, 644 were perpendicular to the z-axis), then the coupling of the magnetic field 650 to the coil 616 is given by M₀·cos(90−θ)·cos(90−ψ).

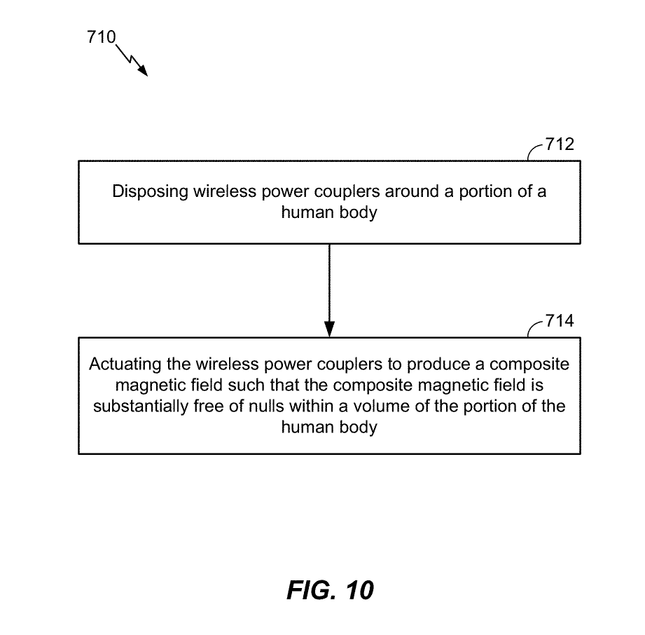

Referring to FIG. 10, with further reference to FIGS. 1-9, a method 710 of providing a composite magnetic field for wirelessly coupling power includes the stages shown. The method 710 is, however, an example only and not limiting. The method 710 may be altered, e.g., by having stages added, removed, rearranged, combined, performed concurrently, and/or having single stages split into multiple stages.

At stage 712, the method 710 includes disposing wireless power couplers around a portion of a human body. For example, the belt transmitter system 412 is placed around a portion of a midsection of the user 418 or the arm cuff transmitter system 414 is placed around a portion of an arm or leg of the user 418. Because the power couplers 432, 434, or the power couplers 512, 514, 516, 518, are disposed around the charging volume 442 in the carrier 440, or around the charging volume 520, the power couplers 432, 434, or the power couplers 512, 514, 516, 518, will be disposed around the portion of the body when the appropriate system, e.g., the system 412 or the system 414 is placed around the portion of the body.

At stage 714, the method 710 includes actuating the wireless power couplers to produce the composite magnetic field such that the composite magnetic field is substantially free of nulls within a volume of the portion of the human body. One or more of the power couplers 432, 434, or the power couplers 512, 514, 516, 518, or the coils 614, 616 are energized, e.g., supplied with current, to produce a magnetic field in the corresponding charging volume 442, 520. The magnetic field produced will preferably have no location at which an intensity of the magnetic field is zero, and more preferably will have no location at which a receiver will not receive sufficient power to power a load of the receiver. For example, the magnetic field may be produced by actuating electrically-conductive loops that are directed in different directions. The loops may be actuated by providing current to the loops, and the current to two or more loops may be in phase. The method 710 may include providing current to one or more other loops that is out of phase with the current provided to one or more other loops. For example, one loop may be provided current that is 90° out of phase with respect to current that is provided to another loop. These loops may be directed perpendicular to each other with respect to an axis of a transmitter system that includes the loops.

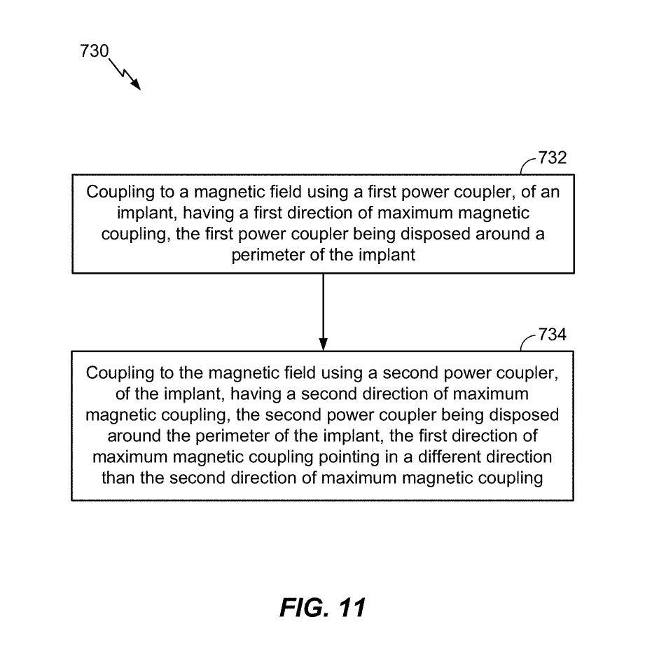

Referring to FIG. 11, with further reference to FIGS. 1-9, a method 730 of providing energy to a load from wirelessly-received power includes the stages shown. The method 730 is, however, an example only and not limiting. The method 730 may be altered, e.g., by having stages added, removed, rearranged, combined, performed concurrently, and/or having single stages split into multiple stages.

At stage 732, the method 730 includes coupling to a magnetic field using a first power coupler, of an implant, having a first direction of maximum magnetic coupling, the first power coupler being disposed around a perimeter of the implant. The first power coupler may be a coil that has a shape that is similar to a cross-sectional shape of the implant along a plane of the first power coupler. For example, the coil 614 of the implant 610 may couple to a magnetic field such as the magnetic field 650.

At stage 734, the method 730 includes coupling to the magnetic field using a second power coupler, of the implant, having a second direction of maximum magnetic coupling, the second power coupler being disposed around the perimeter of the implant, the first direction of maximum magnetic coupling pointing in a different direction than the second direction of maximum magnetic coupling. The second power coupler may be a coil that has a shape that is similar to a cross-sectional shape of the implant along a plane of the second power coupler. For example, the coil 616 of the implant 610 may couple to a magnetic field such as the magnetic field 650.

### OTHER CONSIDERATIONS

Other examples and implementations are within the scope and spirit of the disclosure and appended claims, and may be made or used in accordance with specific requirements. Features implementing functions may also be physically located at various positions, including being distributed such that portions of functions are implemented at different physical locations. Also, as used herein, “or” as used in a list of items prefaced by “at least one of” or prefaced by “one or more of” indicates a disjunctive list such that, for example, a list of “at least one of A, B, or C,” or a list of “one or more of A, B, or C” means A or B or C or AB or AC or BC or ABC (i.e., A and B and C), or combinations with more than one feature (e.g., AA, AAB, ABBC, etc.).

As used herein, unless otherwise stated, a statement that a function or operation is “based on” an item or condition means that the function or operation is based on the stated item or condition and may be based on one or more items and/or conditions in addition to the stated item or condition.

Further, an indication that information is sent or transmitted, or a statement of sending or transmitting information, “to” an entity does not require completion of the communication. Such indications or statements include situations where the information is conveyed from a sending entity but does not reach an intended recipient of the information. The intended recipient, even if not actually receiving the information, may still be referred to as a receiving entity, e.g., a receiving execution environment. Further, an entity that is configured to send or transmit information “to” an intended recipient is not required to be configured to complete the delivery of the information to the intended recipient. For example, the entity may provide the information, with an indication of the intended recipient, to another entity that is capable of forwarding the information along with an indication of the intended recipient.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional stages or functions not included in the figure.

Components, functional or otherwise, shown in the figures and/or discussed herein as being coupled, connected, or communicating with each other are operably coupled. That is, they may be directly or indirectly, wired or wirelessly, connected to enable signal flow between them.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

Further, more than one invention may be disclosed.

1. A wireless-power coupling system comprising:
a first power coupler comprising a first coil, the first coil comprising a first electrically-conductive loop;
a second power coupler comprising a second coil, the second coil comprising a second electrically-conductive loop; and
a third power coupler comprising a third coil, the third coil comprising a third electrically-conductive loop;
wherein the first electrically-conductive loop and the second electrically-conductive loop are non-parallel relative to each other and overlap each other at a first plurality of locations of the first electrically-conductive loop; and
wherein the first electrically-conductive loop and the third electrically-conductive loop are non-parallel relative to each other and overlap each other at a second plurality of locations of the first electrically-conductive loop, the first plurality of locations being distinct from the second plurality of locations.

2. The system of claim 1, wherein the first electrically-conductive loop, the second electrically-conductive loop, and the third electrically-conductive loop share a center.

3. The system of claim 2, wherein the first coil is substantially planar and substantially disposed in a first plane, the second coil is substantially planar and substantially disposed in a second plane, the third coil is substantially planar and substantially disposed in a third plane, wherein each of the first plane, the second plane, and the third plane have a same tilt angle with respect to an axis that extends through the center, and wherein a first intersection line, of an intersection of the first plane and the second plane, intersects a second intersection line, of an intersection of the first plane and the third plane, only at the center.

4. The system of claim 3, further comprising a fourth power coupler comprising a fourth coil, the fourth coil comprising a fourth electrically-conductive loop, the fourth coil being substantially planar and substantially disposed in a fourth plane, wherein a third intersection line, of an intersection of the third plane and the fourth plane, intersects the first intersection line at the center, intersects the axis at the center, is perpendicular to the first intersection line, and is perpendicular to the axis.

5. The system of claim 4, further comprising a power driver electrically coupled to the first coil, the second coil, the third coil, and the fourth coil and configured to provide first power to the first coil and the second coil and to provide second power to the third coil and the fourth coil, the first power being substantially 90 degrees out of phase with respect to the second power.

6. The system of claim 1, further comprising a driver electrically coupled to the first coil, the second coil, and the third coil and configured to provide power to the first coil and the second coil.

7. The system of claim 6, wherein the driver is configured to provide power to the first coil and the second coil concurrently in phase with each other.

8. The system of claim 1, further comprising a wearable housing configured to be worn by a person, the wearable housing containing the first power coupler, the second power coupler, and the third power coupler.

9. The system of claim 1, further comprising:
a biomedical housing containing the first power coupler, the second power coupler, and the third power coupler; and
an electrical load communicatively coupled to the first power coupler, the second power coupler, and the third power coupler.

10. A wireless-power coupling system comprising:
first power coupling means for coupling power wirelessly, the first power coupling means being disposed about a charging volume defined by the wireless-power coupling system to couple power primarily in a first direction;
second power coupling means for coupling power wirelessly, the second power coupling means being disposed about the charging volume to couple power primarily in a second direction that is different from the first direction; and
third power coupling means for coupling power wirelessly, the third power coupling means being disposed about the charging volume to couple power primarily in a third direction that is different from both the first direction and the second direction.

11. The system of claim 10, wherein:
the charging volume is tubular and extends along charging volume axis;
the first power coupling means comprises a first electrically-conductive loop centered on the charging volume axis;
the second power coupling means comprises a second electrically-conductive loop centered on the charging volume axis;
the third power coupling means comprises a third electrically-conductive loop centered on the charging volume axis.

12. The system of claim 11, wherein the first direction is directed away from the charging volume axis by a displacement angle, the second direction is directed away from the charging volume axis by the displacement angle, and the third direction is directed away from the charging volume axis by the displacement angle.

13. The system of claim 12, further comprising fourth power coupling means for coupling power wirelessly, the fourth power coupling means being disposed about the charging volume defined by the wireless-power coupling system to couple power primarily in a fourth direction that is different from the first direction, the second direction, and the third direction, wherein:
the fourth power coupling means comprises a fourth electrically-conductive loop centered on the charging volume axis;
the fourth direction is directed away from the charging volume axis by the displacement angle;
the first direction is opposite the second direction relative to the charging volume axis;
the third direction is opposite the fourth direction relative to the charging volume axis; and
the first direction is perpendicular to the third direction relative to the charging volume axis.

14. The system of claim 13, further comprising a power driver electrically coupled to the first power coupling means, the second power coupling means, the third power coupling means, and the fourth power coupling means and configured to provide first power to the first power coupling means and the second power coupling means and to provide second power to the third power coupling means and the fourth power coupling means, the first power being substantially 90 degrees out of phase with respect to the second power.

15. The system of claim 10, further comprising a driver electrically coupled to the first power coupling means, the second power coupling means, and the third power coupling means and configured to provide power to the first power coupling means and the second power coupling means.

16. The system of claim 15, wherein the driver is configured to provide power to the first power coupling means and the second power coupling means concurrently in phase with each other.

17. The system of claim 10, further comprising housing means for containing the first power coupling means, the second power coupling means, and the third power coupling means and for being worn by a person.

18. The system of claim 10, further comprising:
housing means for containing the first power coupling means, the second power coupling means, and the third power coupling means and for being implanted in a person; and
an electrical load communicatively coupled to the first power coupling means, the second power coupling means, and the third power coupling means.

19. A method of providing a composite magnetic field for wirelessly coupling power, the method comprising:
disposing a plurality of wireless power couplers around a portion of a human body;
actuating the plurality of wireless power couplers to produce the composite magnetic field such that the composite magnetic field is substantially free of nulls within a volume of the portion of the human body.

20. The method of claim 19, wherein:
the plurality of wireless power couplers comprise a first coil, a second coil, and a third coil;
the first coil comprises a first electrically-conductive loop, the second coil comprises a second electrically-conductive loop, and the third coil comprises a third electrically-conductive loop;
the first electrically-conductive loop and the second electrically-conductive loop are non-parallel relative to each other and overlap each other at a first plurality of locations of the first electrically-conductive loop;
the first electrically-conductive loop and the third electrically-conductive loop are non-parallel relative to each other and overlap each other at a second plurality of locations of the first electrically-conductive loop, the first plurality of locations being distinct from the second plurality of locations such that the first electrically-conductive loop, the second electrically-conductive loop, and the third electrically-conductive loop are disposed about three different axes; and
actuating the plurality of wireless power couplers to produce the composite magnetic field comprises providing a first current to the first coil, a second current to the second coil, and a third current to the third coil.

21. The method of claim 20, wherein the first current is in phase with the second current.

22. The method of claim 21, wherein the first current is the second current, and wherein providing the first current and providing the second current comprise provide providing the first current and the second current from a single power amplifier.

23. The method of claim 21, wherein the third current is substantially 90 degrees out of phase with respect to the first current.

24. An implant for receiving power wirelessly, the implant comprising:
a housing having a longitudinal axis;
a first power coupler being disposed around a perimeter of the implant and being substantially planar with a plane of the first power coupler being tilted with respect to the longitudinal axis by a tilt angle between 10° and 80°; and
a second power coupler being disposed around the perimeter of the implant and being substantially planar with a plane of the second power coupler being tilted with respect to the longitudinal axis by a tilt angle between 10° and 80°;
wherein the first power coupler and the second power coupler are symmetrically disposed about the longitudinal axis of the housing.

25. The implant of claim 24, wherein the tilt angle is between 10° and 80°.

26. The implant of claim 25, wherein the first power coupler is a substantially planar coil having a shape similar to a cross-sectional shape of the housing along a plane of the first power coupler.

27. The implant of claim 26, wherein first power coupler is disposed around the perimeter of the housing over a length of the housing having a cylindrical shape, and wherein the first power coupler has an elliptical shape.
